(19) United States
(12) Patent Application Publication
(10) Pub. No.: US 2022/0272456 A1
(43) Pub. Date: Aug. 25, 2022

(54) A TRANSDUCER AND AN ELECTRONIC APPARATUS COMPRISING THE SAME

(71) Applicant: GOERTEK INC., Weifang, Shandong (CN)

(72) Inventors: Chunfa LIU, Weifang, Shandong (CN); Fenglei ZU, Weifang, Shandong (CN); Xinfeng YANG, Weifang, Shandong (CN)

(21) Appl. No.: 17/625,643

(22) PCT Filed: Aug. 13, 2019
(86) PCT No.: PCT/CN2019/100300

§ 371 Date: Jan. 7, 2022

(30) Foreign Application Priority Data
Jul. 8, 2019 (CN) 201910612018.X

(51) Int. Cl. H04R 9/04; H04R 1/28; H04R 7/04; H04R 9/02

(52) U.S. Cl. CPC H04R 9/045; H04R 1/2811; H04R 7/04; H04R 9/025; H04R 2499/11

(57) ABSTRACT

Disclosed is a vibration suspension system and a drive system assembly of a transducer, the vibration suspension system comprises at least one movable device and at least one suspension device, wherein the driving system assembly comprises at least one coil, at least a part of the vibration suspension system is disposed inside the coil, and at least a part of the vibration suspension system passes through an inner hole of the coil, the coil is fixedly disposed inside the transducer, and a movement direction of the movable device is orthogonal or partially orthogonal to an axis direction of the coil. Such a design enables one or more parts of the vibration suspension system to share space with one or more parts of the drive system assembly, which is more benefit to reduce an internal space of the device and to achieve the purpose of further miniaturization.

### TECHNICAL FIELD

The present disclosure relates to a transducer field, more specifically, relates to a transducer, as well as relates to an electronic apparatus using the transducer.

### BACKGROUND ART

Transducers are important devices that perform energy conversion among electronic apparatus. For example, in a field of consumer electronic products such as a mobile phone, a tablet computer, a laptop and the like, various types of transducers are commonly used as main devices for their sound production and vibration, and vibration suspension systems and drive system assemblies of the transducers have very important effects on an overall performance and structure of the transducers.

The designs of vibration suspension systems and drive system assemblies of mainstream micro transducers comprise: a. a structure in which a voice coil and a movable device are directly attached (for example, the speaker structure illustrated in FIG. 1); b. a moving iron structure in which an armature with one end fixed is combined with a vibrating component through a transmission component (for example, the moving iron receiver illustrated in FIG. 2; and c. a vibration motor in which a magnetic circuit and a vibration part are combined and share space. The main shortcomings of these types of transducers are:

1. The coil 4′ and the vibrating part of the moving coil transducer (that is, a suspension device 2′ and a reinforcing part 3′, in particular, the suspension device is a diaphragm) are upper and lower structures, and the coil and the magnetic circuit (including a magnetic conductive member and permanent magnet 5′) share space, but the coil cannot share space with the suspension system;

2. In the moving iron type transducer, the suspension device 2′ and the armature (that is, a transmission mechanism 6) are attached to each other as much as possible, thus the coil and the magnetic circuit share space, as well as the coil and the suspension system share space at the same time to a certain extent in a vibration direction. However, the coil cannot share space with the magnetic circuit, as well as the coil cannot share space with the suspension system in a direction orthogonal to the vibration direction;

3. The magnetic circuit and the vibrator of the vibration motor are combined, so as to ensure that the magnetic circuit share space with the suspension system in a thickness direction of the device, however the coil cannot share space with the suspension system.

Therefore, it is necessary to improve the vibration suspension system and the driving system assembly for the transducer and the electronic apparatus of the prior art to avoid the above shortcomings.

### SUMMARY

In order to solve the above technical problems, the technical solution provided by the present disclosure is: a transducer comprising a vibration suspension system and a drive system assembly, the vibration suspension system comprises:

at least one movable device and at least one suspension device,

wherein the driving system assembly comprises at least one coil; and

wherein at least a part of the vibration suspension system is disposed inside the coil, at least a part of the vibration suspension system passes through an inner hole of the coil, the coil is fixedly disposed inside the transducer, and a movement direction of the movable device is orthogonal or partially orthogonal to an axis direction of the coil.

As an improvement, the movable device is provided with a magnetic conductive material, at least a part of the magnetic conductive material is disposed in an area where an alternating magnetic field and a static magnetic field overlap with each other, so that the magnetic conductive material converges the static magnetic field and the alternating magnetic field, and a magnetic field force generated by an interaction between the static magnetic field and the alternating magnetic field is applied to the magnetic conductive material, to drive the vibration suspension system to move.

As an improvement, the suspension device is one of an elastic sheet, a spring and a diaphragm sheet or a combination thereof.

As an improvement, the transducer is a magnetic potential speaker, the movable device is a diaphragm, the diaphragm defines a front acoustic cavity and a rear acoustic cavity of the magnetic potential speaker, and the diaphragm forms a part of the suspension device.

As an improvement, the movable device or the suspension device passes through the inner hole of the coil.

As an improvement, the magnetic conductive material has a planar structure.

As an improvement, the magnetic conductive material is provided in one set or a plurality of sets, and each set of the magnetic conductive material is disposed on both side surfaces of the diaphragm.

As an improvement, the static magnetic field is formed at one side of the coil.

As an improvement, the coil is provided in a plurality of coils, and the static magnetic field is formed between the plurality of coils.

The present disclosure proposes to directly dispose all or a part of the vibration suspension system inside the coil, and all or a part of the movable device vibrates inside the coil. This design enables one or more parts of the vibration suspension system to share space with one or more parts of the drive system assembly, which is more benefit to reduce an internal space of the device and to achieve the purpose of further miniaturization.

According to another aspect of the present disclosure, the present disclosure provides an electronic apparatus, which comprises the above-described transducer.

As an improvement, the electronic apparatus is a mobile phone, a tablet computer, a TV, an auto audio or a loudspeaker.

Through the following detailed description of exemplary embodiments of the present disclosure with reference to the accompanying drawings, other features and advantages of the present disclosure will become clear.

### BRIEF DESCRIPTION OF THE DRAWINGS

The accompanying drawings, which are incorporated in the specification and constitute a part of the specification, illustrate embodiments of the present disclosure, and are used to explain the principle of the present disclosure together with the description thereof.

FIG. 1 is a schematic diagram of a structure of a moving coil type transducer in the prior art 1;

FIG. 2 is a schematic diagram of a structure of a moving iron type transducer in the prior art 2;

FIG. 3 is a schematic diagram of a structure of a vibration suspension system and a drive system assembly of a transducer according to an embodiment 1 of the present disclosure;

FIG. 4 is a schematic diagram of a structure of a vibration suspension system and a drive system assembly of a transducer according to an embodiment 2 of the present disclosure;

FIG. 5 is a schematic diagram of a vibration suspension system and a drive system assembly of a transducer according to an embodiment 3 of the present disclosure; and

FIG. 6 is a schematic diagram of a specific structure corresponding to the embodiment in FIG. 5 and an operation principle thereof.

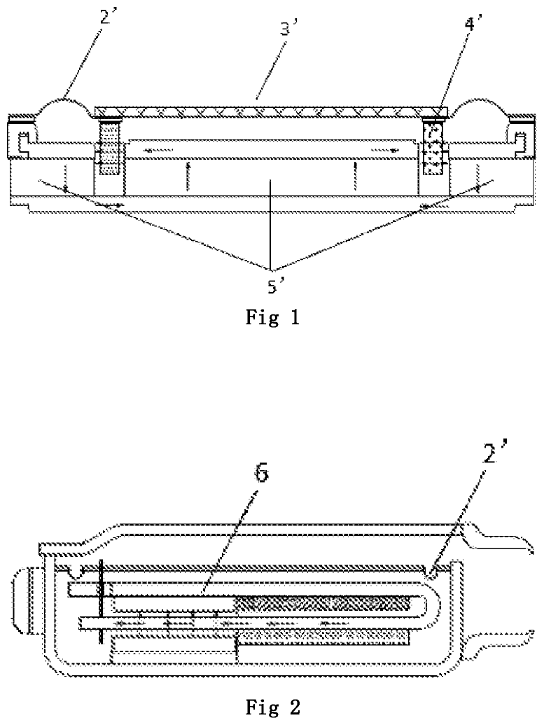

### DESCRIPTION OF THE REFERENCE SIGNS

1. Magnetic conductive material; 2. suspension device; 2′, suspension device; 3. reinforcing portion; 3′, reinforcing portion; 4. coil; 4′, coil; 41, first coil; 42, second coil; 5. permanent magnet; 5′, permanent magnet; 51, first permanent magnet; 52, second permanent magnet; 6, transmission mechanism; A, static magnetic field; B, alternating magnetic field; C, vibration suspension system; D, movable device.

### DETAILED DESCRIPTION OF EMBODIMENTS

Various exemplary embodiments of the present disclosure will now be described in detail with reference to the accompanying drawings. It should be noted that the relative arrangement, numerical expressions and numerical values of the parts and steps described in these embodiments do not limit the scope of the present disclosure unless otherwise specified.

The following description of at least one exemplary embodiment is only illustrative in fact and is in no way intended to limit the present disclosure and its application or use.

The technologies, methods and devices known to those skilled in the art may not be discussed in detail, but where appropriate, the technologies, methods and devices shall be regarded as a part of the specification.

In all of the examples shown and discussed here, any specific value should be interpreted as merely exemplary and not as a limitation. Therefore, other examples of exemplary embodiments may have different values.

It should be noted that similar reference numerals and letters represent similar items in the following drawings. Therefore, once an item is defined in a drawing, it does not need to be further discussed in subsequent drawings.

The present disclosure provides a transducer comprising a vibration suspension system and a drive system assembly, wherein the vibration suspension system comprises at least one movable device and at least one suspension device; the drive system assembly comprises at least one coil; at least a part of the vibration suspension system is disposed inside the coil, and at least a part of the vibration suspension system passes through an inner hole of the coil, the coil is fixedly disposed inside the transducer, and a movement direction of the movable device is orthogonal or partially orthogonal to an axis direction of the coil.

Hereinafter, the present disclosure will be further described in combination with the accompanying drawings.

### Embodiment 1

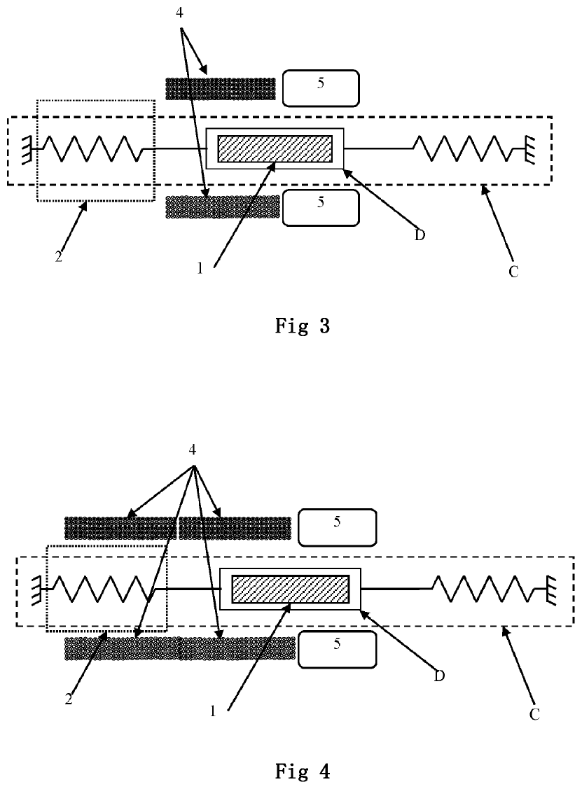

As shown in FIG. 3, in the present embodiment, a transducer structure under the concept of the present disclosure is illustrated. A vibration suspension system C of the transducer structure comprises a movable device D being capable of reciprocating movement and a suspension device 2, and the vibration suspension system C is suspended in the transducer through the suspension device 2. The specific structure of the movable device D is different according to different application scenarios: for example, when it is used in a miniature speaker, the movable device D may be a diaphragm, and when it is used in a micro motor, the movable device D may be a counterweight. The specific structure of the movable device D can be flexibly selected according to the above-described different products, without affecting the implementation of the present disclosure.

The suspension device 2 provides an elastic restoring force for the movable device D to return to a balance position when the movable device D moves. In a specific implementation, the suspension device 2 is made of a flexible material with a certain degree of elasticity. Since the suspension device 2 is required to provide the elastic restoring force for the movable device D, one end thereof needs to be connected and fixed with at least a part of the movable device D, and the other end thereof is fixed in the transducer when the suspension device 2 is assembled. Therefore, when the movable device D vibrates, the suspension device 2 occurs elastic deformation based on its own elasticity, due to the vibration of the movable device D applies compress force thereon, thereby the suspension device 2 provides a restoring force for the movable device D to return to the balance position.

Specifically, the suspension device 2 may be a structure such as an elastic diaphragm, an elastic sheet or a spring etc. or a combination of the above-described structures, and in a specific design, the suspension device 2 preferably reserves a space for the elastic deformation in a moving direction of the movable device D. In a case that the diaphragm is selected as the suspension device 2, it can be configured as having at least one arc portion convex or concave in the movement direction. For another example, in a case that the elastic sheet is selected as the suspension device, a V type elastic sheet, a C type elastic sheet or any combination thereof may be selected, and other forms of elastic sheet may also be selected, and the specific form is not limited.

In this embodiment, the driving system assembly comprises one coil 4, and a part of the movable device D in the vibration suspension system C passes through an inner hole of the coil 4, so that it partially shares space with the coil 4. The “share space” mentioned herein specifically means that respective components are placed in parallel and there is no stacking among them. Specifically, the movable device D comprises a magnetic conductive material 1, and a part of the magnetic conductive material 1 passes through the inner hole of the coil 4.

In this embodiment, in addition to the coil 4, the drive system assembly further comprises two magnetic fields, i.e., a static magnetic field A and an alternating magnetic field B, wherein the static magnetic field A is generated by two correspondingly disposed permanent magnets 5, and the alternating magnetic field B is generated by an electrical current passing through the coil 4. In addition, the static magnetic field A and the alternating magnetic field B are configured to be orthogonal or partially orthogonal. The magnetic conductive material 1 is disposed parallel to a direction of the alternating magnetic field B, that is, disposed along a horizontal direction. When there is no electrical current passing through an alternating magnetic field generating device, i.e., the coil 4, that is, when the alternating magnetic field B has not been generated, in an idealized state, the magnetic conductive material 1 itself will be subjected to an static magnetic force of the static magnetic field A, and the static magnetic force appears as equal in magnitude and opposite in direction on two sides of the magnetic conductive material 1, therefore the overall static magnetic force appears as a resultant force of 0, and thereby the magnetic conductive material 1 can be kept in the balance position. In other cases, the resultant force of the static magnetic force applied on the magnetic conductive material 1 by the static magnetic field A is not equal to 0, at this time, the magnetic conductive material 1 itself has a tendency to deviate from the balance position, but due to the existence of the suspension device 2, the elastic restoring force can be provided to keep the magnetic conductive material 1 in the original balance position.

When the alternating magnetic field B is generated, the magnetic conductive material 1 itself is positioned in an area where the static magnetic field A and the alternating magnetic field B are overlapped. The magnetic conductive material 1 converges the magnetic fields, and an interaction force will certainly be generated between the alternating magnetic field B and the static magnetic field A, and this interaction force acts on the magnetic conductive material 1, so that the magnetic conductive material 1 drives a movement of the vibration suspension system C. During this reciprocating movement, since the movable device D is connected with the suspension device 2, the suspension device 2 may provide the movable device D with elastic restoring force, that is, if the vibration suspension system C moves downward, the suspension device 2 provides an upward pulling force, and if the vibration suspension system C moves upward, the suspension device 2 may provide a downward pulling force. Thus, the magnetic conductive material 1 moves as a whole under the overall interaction force of the static magnetic field A, the alternating magnetic field B and the suspension device 2.

It should be noted that, in the present disclosure, the overall movement of the magnetic conductive material 1 in the magnetic potential transducer means that the magnetic conductive material 1 is freely disposed on the suspension device 2, and the boundary of the magnetic conductive material is not clamped to other parts, which is essentially different from the U-shaped or T-shaped armature structure of the moving iron transducer described in the above.

More specifically, when the coil 4 is supplied with an alternating current signal, the alternating magnetic field B may be generated, and the magnetic conductive material 1 is polarized under the action of the alternating magnetic field B, that is, one end thereof is a N pole and the other end thereof is a S pole. The two permanent magnets 5 may also be configured such that the magnetic poles of the two opposite ends are opposite, that is, one end is a N pole and the other end is a S pole in the opposite two ends. One end of the magnetic conductive material 1 is also located in the static magnetic field A generated by the permanent magnet 5, in this way, the polarized magnetic conductive material 1 generates an attractive force and a repulsive force with the opposite two ends of the permanent magnet. Under the action of this magnetic field force, the magnetic conductive material 1 may perform reciprocating movement, thereby driving the movable device D to move in a direction orthogonal to an axis direction of the coil 4 as a whole relative to the coil 4 fixed on the transducer. For example, in the present embodiment, the coil 4 is disposed in the horizontal direction, and the movable device D moves in a vertical direction as a whole. Certainly, in a specific design, the moving direction of the movable device D may also be partially orthogonal to the axial direction of the coil 4.

As described above, when applied to a miniature speaker, the magnetic conductive material 1 may be directly connected and fixed with the diaphragm together. It is easy to understand that, when the magnetic conductive material 1 performs reciprocating movement, it may certainly drive the flexible diaphragm to perform reciprocating movement, thereby realizing sound generation function thereof. When applied to a miniature motor, the movable device D further comprises a counterweight. Similarly, the counterweight may be connected and fixed with the magnetic material 1 and the counterweight vibrates as a whole under the driving of the magnetic material 1.

### Embodiment 2

As shown in FIG. 4, a structure of another transducer under the concept of the present disclosure is illustrated. The embodiment 2 is difference from the embodiment 1 in that, in this embodiment, two coils are provided as the driving unit, and the two coils are arranged in parallel. The specific operation mode and operation principle are the same as those illustrated in the embodiment 1 and will not be repeated herein.

### Embodiment 3

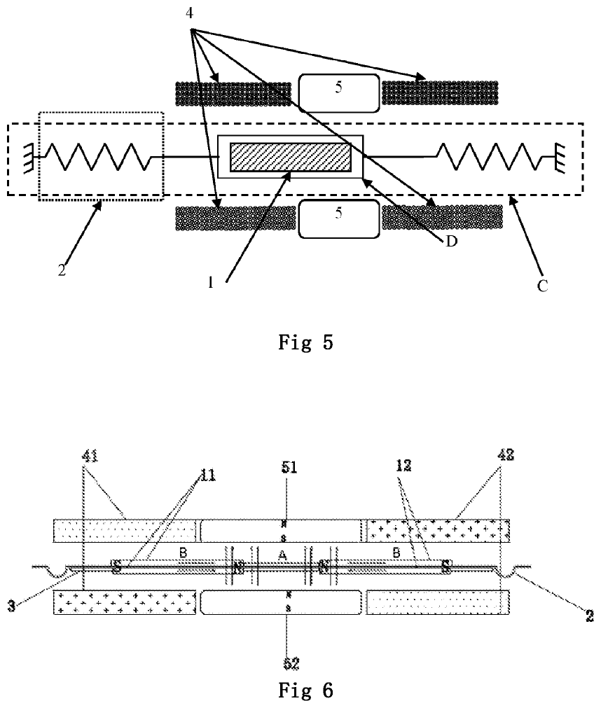

As shown in FIG. 5, a structure of further another transducer under the concept of the present disclosure is illustrated. The embodiment 3 is difference from the embodiment 1 in that, the coil 4 as the driving unit is provided in two coils 4 and the two coils are respectively disposed on two sides of the magnetic conductive material 1 in the horizontal direction, and the permanent magnet 5 is disposed between the two coils. A part of the magnetic conductive material 1 is disposed inside the coil 4 and is partially shared space with the coil 4.

FIG. 6 provides a specific structural configuration corresponding to the embodiment of FIG. 5, which is a magnetic potential speaker structure. The magnetic material 1 thereof is also provided in two sets, and each set of magnetic material has two sheet-shaped magnetic materials which are marked as a first magnetic material set 11 and a second magnetic material set 12, respectively. The movable device D thereof includes a diaphragm. The operation principle of this embodiment will be specifically described below with reference to FIG. 6.

Specifically, in this embodiment, coils 4 are provided in two coils, which are a first coil 41 and a second coil 42 respectively. The permanent magnets 5 are also correspondingly provided in two permanent magnets, i.e., a first permanent magnet 51 and a second permanent magnet 52, and the first permanent magnet 51 and the second permanent magnet 52 are oppositely disposed on two sides of the magnetic conductive material 1, that is, the first permanent magnet 51 may be disposed on an upper side of the magnetic conductive material 1, and the second permanent magnet 52 is disposed on a lower side of the magnetic conductive material 1 correspondingly.

Wherein, the alternating magnetic field B is an alternating magnetic field formed by an electrical current passing through the coil 4, and the magnetic conductive material 1 is disposed in parallel to the magnetic field direction of the alternating magnetic field B, and a part of the magnetic conductive material 1 passes through the inner hole of the coil 4. The alternating magnetic field A is the static magnetic field formed by the permanent magnet 5, and the direction of the static magnetic field A is disposed in the vertical direction, and is located between the two coils. Certainly, the distribution of the static magnetic field A may also be located on one side of the coil 4. The specific arrangement manner may not be limited by the above-described embodiment.

In order to enable the magnetic conductive material 1 to drive the vibrating device to vibrate, in this embodiment, from the perspective of the distribution of the various components, an end of the first magnetic conductive material set 11 is located in the alternating magnetic field B generated by the first coil 41, and at least a part of the first magnetic conductive material set 11 is located in the static magnetic field A generated by both of the first permanent magnet 51 and the second permanent magnet 52. Similarly, an end of the second magnetic conductive material set 12 is located at the alternating magnetic field B generated by the second coil 42, and at least a part of the second magnetic conductive material set 12 is located in the static magnetic field A generated by both of the first permanent magnet 51 and the second permanent magnet 52.

Magnetic poles of opposite ends of the first permanent magnet 51 and the second permanent magnet 52 are opposite. In this embodiment, it may be assumed that the magnetic poles of the opposite ends of the first permanent magnet 51 and the second permanent magnet 52 are a S pole and a N pole, respectively, and the magnetic poles of the two ends distanced away from each other are a N pole and a S pole, respectively. Similarly, the first coil 41 and the second coil are supplied with alternating current signals in opposite directions, wherein “⊕” indicates that a direction of the current is perpendicular to the paper surface inward, and “⊙” indicates that a direction of the current is perpendicular to the paper surface outward. The first magnetic conductive material set 11 is polarized in the alternating magnetic field B generated by the first coil 41, and the second magnetic conductive material set 12 is polarized in the alternating magnetic field B generated by the second coil 42. It may be determined according to the right-hand rule that, the magnetic poles at the adjacent ends of the first magnetic conductive material set 11 and the second magnetic conductive material set 12 are both N poles, and the magnetic poles of the two ends distanced away from each other are both S poles. Arrows in FIG. 6 respectively illustrate a direction of a magnetic induction line inside the magnetic conductive material 1 after polarization and a direction of a magnetic induction line of the static magnetic field A. Taking the first magnetic conductive material set 11 as an example, one end thereof is N pole, and one end of the first permanent magnet 51 is S pole and is close to the N pole of the first magnetic conductive material set 11, and one end of the second magnetic conductive material set 52 is N pole and is also close to the N pole of the first magnetic conductive material set 11. Therefore, the first magnetic conductive material set 11 will be respectively subjected to an attractive force and a repulsive force of the static magnetic field between the first permanent magnet 51 and the second permanent magnet 52, and the two forces are in the same direction. Similarly, the second magnetic conductive material set 12 will also be subject to the attractive force and repulsive force of the static magnetic field between the same first permanent magnet 51 and the same second permanent magnet 52, in the meanwhile, under the action of the suspension device 2, the magnetic conductive material 1 may perform a reciprocating movement under the interaction of the static magnetic field A and the alternating magnetic field B.

That is, in this vibration suspension system C, the magnetic conductive material 1 itself participates in the vibration as a whole and constitutes a part of the movable device D based on its own magnetic converging effect and the interaction force of the two external magnetic fields arranged correspondingly.

Of course, this embodiment only shows one possible implementation form, wherein the directions of the magnetic induction lines of the static magnetic field A and the alternating magnetic field B are not limited in the directions shown in the drawings, for example, the magnetic poles of the opposite ends of the first permanent magnet 51 and the second permanent magnet 52 may be disposed to be opposite to those shown in the figures. In addition, the directions of the applied current of the first coil 41 and the second coil 42 may also be opposite to those shown in the figures. Correspondingly, the polarities of the ends adjacent to each other and the ends distanced away from each other of the magnetic conductive material 1 after polarization may also be opposite, but the corresponding attractive force and repulsive force may still be generated, and the magnetic conductive material still can perform reciprocating movement under the action of the alternating magnetic field and the static magnetic field.

It should be noted that, the suspension device 2 is a diaphragm, and the diaphragm is directly connected and fixed to the magnetic conductive material 1, therefore the diaphragm performs reciprocating movement under the drive of the magnetic conductive material 1. At the same time, the diaphragm itself has an elasticity, and the edge portion thereof itself also provides an elastic restoring force for the movable device D to return to the balance position during the reciprocating movement.

It is well known to those skilled in the art that, when the suspension device 2 (specifically including the diaphragm) vibrates, in order to improve the phenomenon of split vibration, a reinforcing portion 3 may be provided on a surface of the suspension device 2, and the reinforcing part 3 is generally a material component with greater rigidity.

In addition, in the specific implementation, in the miniature transducer in the consumer electronics field, in order to increase the driving force or reduce a first-order resonance frequency to improve the low-frequency performance, inverse stiffness may be generated in the magnetic circuit design. Both of the inverse stiffness and the driving force are closely related to the structure of the magnetic circuit, therefore it is difficult to individually design them to meet their respective requirements, that is, requiring a large driving force may lead to excessive inverse stiffness, and requiring moderate inverse stiffness may lead to too small driving force. Herein, for the convenience of explanation, two concepts will be explained. Firstly, the first-order resonant frequency refers to a resonant frequency in a first-order mode. Secondly, inverse stiffness, also known as magnetic stiffness, that means, when the magnetic conductive material (comprising soft magnetic material and hard magnetic material) is close to an area with high magnetic flux density, the force on the magnetic conductive material gradually increases and the direction of the force is consistent with the moving direction of the magnetic conductive material. The change rate of the force to the displacement of the magnetic conductive material is referred to as the inverse stiffness of the magnetic conductive material.

Therefore, in consideration of the above factors, an additionally elastic component may be individually provided as an inverse stiffness balancing device, to reconstitute a force balancing device. The following factors may be taken into account in the specific design.

1) The inverse stiffness of the micro transducer is measured by simulation or test, if the inverse stiffness is non-linear, the curve of the static magnetic force applied on the movable device according to the change of the displacement of the movable device must be obtained by simulation or test.

2) According to the design requirement for the first-order resonant frequency and in combination with the measurement result of the inverse stiffness, the stiffness requirement for the force balancing device is obtained. According to this requirement and in combination with an internal spatial structure of the micro transducer, at least one inverse stiffness balancing device is designed, and the structure thereof may take many forms, for example, the above-mentioned elastic sheet, spring, magnetic spring, etc.

In addition to the above factors, the design of the inverse stiffness balancing device shall follow its own design requirements. For example, the structure of the elastic sheet or the spring must meet the requirement that the stress generated when it is stretched or compressed to the limit displacement is less than the yield strength of the member. For another example, the structure of the magnetic spring must meet the requirement that it does not exceed the action scope of its magnetic field force when it is stretched or compressed to the limit displacement.

It can be seen that in this embodiment, in addition to the elastic recovery function of the diaphragm, the inverse stiffness is balanced by additionally providing the inverse stiffness balancing device. This design may bring the following advantages.

a) The stiffness balance and the inverse stiffness balance of the force balancing device are designed individually, so that the driving force may be designed independently regardless of the magnitude of the inverse stiffness;

b) The stiffness of the force balancing device is only dependent on its own structure, so that the total stiffness of the system may be adjusted by adjusting the stiffness, so as to indirectly adjust the first-order resonant frequency of the system.

The applicant further explains from the perspective of the assembly of the magnetic potential speaker of this embodiment. The speaker itself provides a bracket as a peripheral frame, in which the permanent magnets 5, the first coil 41 and the second coil 42 may be positioned in the frame provided by the bracket. Specifically, the first coil 41, the permanent magnets 5 and the second coil 42 are assembled from left to right in the horizontal direction, that is, the first coil 41 and the second coil 42 are fixed at two sides of the permanent magnets 5 respectively, and maintain a certain gap with the permanent magnets 5. After the two permanent magnets are mounted correspondingly, a vibration space is formed in the vibration direction of the transducer. In the vibration space, the suspension device 2 and the magnetic conductive material 1 driving the suspension device 2 to vibrate are mounted, wherein the magnetic conductive material 1 is connected and fixed on a surface of the suspension device 2, and there is a certain distance between the magnetic conductive material 1 and the second ends of the first permanent magnet 51 and the second permanent magnet 52. In this way, it may ensure that there is a space for the reciprocating motion under the action of the static magnetic field A and the alternating magnetic field B.

In combination with the above embodiments, it can be known that all or part of the vibration suspension system C of the present disclosure passes through the inner hole of the coil 4, in this way, it is possible to achieve entire or partial share space, and in combination with the driving of the magnetic conductive material 1, it can not only achieve higher energy conversion rate, but also can save product space and meet the requirements of thin type. Compared with the prior art, the design of this new type of vibration suspension system and drive system assembly has obvious technical advantages. The details are as follows:

1. Compared with the design that the voice coil and the vibrator of the moving coil speaker are directly attached, the design where the vibration suspension system is placed inside the coil proposed by the present disclosure not only enables the coil to share space with the magnetic circuit, but also enables the coil to share space with the suspension system.

2. Compared with the design that the armature and the diaphragm of the moving iron receiver are directly attached to each other, the design proposed by the present disclosure not only enables the coil to share space with the magnetic circuit, as well as the coil to share space with the suspension system at the same time in the vibration direction, but also enables the coil to share space with the suspension system in the direction orthogonal to the vibration direction;

3. Compared with the design in which the magnetic circuit and the vibrator of the linear vibration motor are combined, the design proposed by the present disclosure enables the magnetic circuit to share space with the coil as well as the coil to share space with the suspension system in the thickness direction of the device at the same time.

It should be noted that:

firstly, the magnetic conductive material 1 may have a planar sheet structure, and may be provided in one piece or two pieces or in a plurality of sets, and the number of the magnets that may be provided for each set of magnetic conductive material is not limited, moreover, the composition of the magnetic conductive material does not necessarily have to be formed by the magnetizer, for example, when the magnetic conductive material is connected to the diaphragm, it may also be composed of a magnetic conductive material covering a part of the surface of the diaphragm by coating or other methods;

secondly, in order to make the vibration of the movable device tend to be balanced, the magnetic conductive material is preferably symmetrically distributed on the surface of the diaphragm, of course, when it is provided in a plurality of sets, it may also in the mode of staggered distribution, etc.;

thirdly, in the specific implementation of the present disclosure, it may be applied not only to square transducers, but also to circular transducers or transducers with other shapes, the transducer mentioned herein includes transducer products such as speakers and motors. Correspondingly, the diaphragm may be provided in a square or circular shape, etc.;

fourthly, the number of the static magnetic field generating device, the alternating magnetic field generating device, the movable device, the suspension device and the driving assembly in the magnetic potential transducer may be one or more.

Fifthly, the drawings in the specification of the present disclosure show a structure in which a part of the movable device passes through the inner hole of the coil. In fact, in the design of the product, it may also configured such that at least a part of the suspension device passes through the inner hole of the coil, and both the movable device and the suspension device have parts that pass through the inner hole of the coil at the same time.

Sixthly, the drive systems shown in the drawings of the present disclosure all include permanent magnets, but in fact, when the drive system only includes coils, the force relied on the electromagnet can also be applied to transducer products.

The present disclosure also provides an electronic apparatus, which applies the above-described vibration suspension system and the drive system assembly for the transducer, and the electronic apparatus may specifically be terminal products such as a mobile phone, a tablet computer, a TV, an auto audio or a loudspeaker.

It should be noted that, the structural design of the present disclosure starts with magnetic potential transducers of various structures, such as speakers, motors, and multifunctional products that integrate vibration and sound generation in the field of consumer electronics, and products in the field of non-consumer electronic products such as an automotive electronic, a smart audio and other products, for example, a motor and a loudspeaker that may output sound radiation and achieve a certain displacement or vibration energy may be also included.

Although some specific embodiments of the present disclosure have been described in detail by examples, those skilled in the art should understand that the above examples are only for illustration and not to limit the scope of the present disclosure. Those skilled in the art should understand that the above embodiments may be modified without departing from the scope and spirit of the present disclosure. The scope of the present disclosure is defined by the appended claims.

1. A transducer comprising vibration suspension system and a drive system assembly, wherein the vibration suspension system comprises
at least one movable device and at least one suspension device,
wherein the driving system assembly comprises at least one coil; and
wherein at least a part of the vibration suspension system is disposed inside the coil, at least a part of the vibration suspension system passes through an inner hole of the coil, the coil is fixedly disposed inside the transducer, and a movement direction of the movable device is orthogonal or partially orthogonal to an axis direction of the coil.

2. The transducer of claim 1, wherein
the movable device is provided with a magnetic conductive material, at least a part of the magnetic conductive material is disposed in an area where an alternating magnetic field and a static magnetic field overlap with each other, so that the magnetic conductive material converges the static magnetic field and the alternating magnetic field, and a magnetic field force generated by an interaction between the static magnetic field and the alternating magnetic field is applied to the magnetic conductive material, to drive the vibration suspension system to move.

3. The transducer of claim 1, wherein the suspension device is one of an elastic sheet, a spring and a diaphragm sheet, or a combination thereof.

4. The transducer of claim 1, wherein the transducer is a magnetic potential speaker, the movable device is a diaphragm, the diaphragm defines a front acoustic cavity and a rear acoustic cavity of the magnetic potential speaker, and the diaphragm forms a part of the suspension device.

5. The transducer of claim 1, wherein the movable device and/or the suspension device passes through the inner hole of the coil.

6. The transducer of claim 5, wherein the magnetic conductive material has a planar structure.

7. The transducer of claim 6, wherein the magnetic conductive material is provided in one set or a plurality of sets, and each set of the magnetic conductive material is disposed on both side surfaces of the diaphragm.

8. The transducer of claim 2, wherein the static magnetic field is formed at one side of the coil.

9. The transducer of claim 2, wherein the coil is provided in a plurality of coils, and the static magnetic field is formed between the plurality of coils.

10. An electronic apparatus, comprising the transducer of claim 1.

11. The electronic apparatus of claim 10, wherein the electronic apparatus is a mobile phone, a tablet computer, a TV, an auto audio or a loudspeaker.
